(19) United States
(12) Patent Application Publication
(10) Pub. No.: US 2018/0173484 A1
(43) Pub. Date: Jun. 21, 2018

(54) METHOD AND SYSTEM FOR DISPLAYING WEARABLE DEVICE DISPLAY INFORMATION

(71) Applicant: Huizhou TCL Mobile Communication Co., LTD, Hui Zhou (CN)

(72) Inventor: Jie Zhang, Hui Zhou (CN)

(21) Appl. No.: 15/566,291

(22) PCT Filed: Sep. 8, 2016
(86) PCT No.: PCT/CN2016/098442

§ 371 Date: Oct. 13, 2017

(30) Foreign Application Priority Data
Oct. 10, 2015 (CN) 201510655682.4

(51) Int. Cl. G06F 3/14; G06F 1/16; G02B 27/01

(52) U.S. Cl. CPC G06F 3/1423; G06F 3/1454; G02B 27/017; G06F 1/163

(57) ABSTRACT

A method and a system for displaying wearable device display information can include a master wearable device detecting whether a user has put on a slave wearable device via a body transmission channel; when it is determined that the user has put on the slave wearable device, determining priority of the master wearable device and the slave wearable device, and when the priority of the slave wearable device is higher than the priority of the master wearable device, transmitting the display information to be displayed to the slave wearable device for display via the body transmission channel.

### FIELD OF THE INVENTION

The present invention relates to the field of communication technologies, and in particular to a method and a system for displaying wearable device display information.

### DESCRIPTION OF THE RELATED ART

Along with technology development, electronic devices, in particular wearable devices, may be increasingly widely used. As wearable devices are light and portable, they may be increasingly popular among the public. As wearable devices become common on the market, there are many types of wearable devices available. Many users may put on multiple wearable devices and the most common ones may be smart watches and smart glasses.

Both smart watches and smart glasses can display information. When a user puts on one wearable device, the display information may only displayed be on the wearable device on the user. When a user puts on multiple wearable devices, the user may need to manually set up a wearable device to display information. Specifically, when a user wears a smart watch, the display information may only be displayed on the smart watch; when a user wears a smart watch and a pair of smart glasses at the same time, it may be necessary for the user to manually set up whether the display information is displayed on the smart watch or the smart glasses. As it may require a manual operation to display the display information on a wearable device, and as the operation may be complicated, a user may tend to get a poor experience.

Therefore it is necessary to provide a method and a system for displaying wearable device display information to solve the above problem.

### SUMMARY OF THE INVENTION

In an embodiment, a system for displaying wearable device display information, comprises a master wearable device and a slave wearable device, the master wearable device may be worn on a user's body. The master wearable device may comprise a first bus, a first memory, a first processor, a first communication interface, and a first monitor. The first memory, the first processor, the first communication interface, and the first monitor may be connected to the first bus. The slave wearable device may comprise a second bus, a second memory, a second processor, a second communication interface, and a second monitor. The second memory, the second processor, the second communication interface, and the second monitor may be connected to the second bus. The first memory may store a first program command. The first processor may be configured to execute the first program command. The second memory may store a second program command. The second processor may be configured to execute the second program command, and both the first communication interface and the second communication interface may be in contact with skin to ensure an openness of a body transmission channel, wherein:

The first processor can execute the first program command to control the first communication interface to detect whether a user has put on the slave wearable device via a body transmission channel formed within the user body;

When the first processor executes the first program command and determines that the user has put on the slave wearable device, the first processor can determine priority of the master wearable device and the slave wearable device.

The first processor can execute the first program command to control the first communication interface, when it is determined that the priority of the slave wearable device is higher than the priority of the master wearable device, to transmit the display information to be displayed to the second communication interface via the body transmission channel.

When the second communication interface receives the display information transmitted from the first communication interface, the second processor can execute the second program command to control the second monitor to display the display information.

When the first processor executes the first program command and determines that the user has put on the slave wearable device, the first processor can further execute the first program command to control the first communication interface to transmit handshake information to the second communication interface regularly via the body transmission channel. The second processor can execute the second program command to control the second communication interface to transmit answer information corresponding to the handshake information to the first communication interface via the body transmission channel. When the first processor executes the first program command and when no corresponding answer information is received after the first communication interface transmits the handshake information, the first processor can confirm that the user has taken off the slave wearable device, and when the first processor confirms that the user has taken off the slave wearable device, the first processor can control the first monitor to display the display information.

The first processor can determine that the user has put on the slave wearable device when the answer information is received, by the first communication interface, for more than a preset number of times within a preset time threshold.

The master wearable device can be a smart watch, and the slave wearable device can be a pair of smart glasses.

In an embodiment, a system for displaying wearable device display information comprises a master wearable device and a slave wearable device, the master wearable device can be worn on the user's body, the master wearable device may comprise a first bus, a first memory, a first processor, a first communication interface, and a first monitor. The first memory, the first processor, the first communication interface, and the wearable device may comprise a second bus, a second memory, a second processor, a second communication interface, and a second monitor. The second memory, the second processor, the second communication interface, and the second monitor may be connected to the second bus. The first memory may store a first program command. The first processor can be configured to execute the first program command. The second memory can store a second program command, and the second processor can be configured to execute the second program command.

The first processor can execute the first program command to control the first communication interface to detect whether a user has put on the slave wearable device via a body transmission channel formed within the user body.

When the first processor executes the first program command and determines that the user has put on the slave wearable device, the first processor can determine priority of the master wearable device and the slave wearable device.

The first processor can execute the first program command to control the first communication interface, when it is determined that the priority of the slave wearable device is higher than the priority of the master wearable device, to transmit the display information to be displayed to the second communication interface via the body transmission channel.

When the second communication interface receives the display information transmitted from the first communication interface, the second processor can execute the second program command to control the second monitor to display the display information.

When the first processor executes the first program command and determines that the user has put on the slave wearable device, the first processor can further execute the first program command to control the first communication interface to transmit handshake information to the second communication interface regularly via the body transmission channel, and the second processor can execute the second program command to control the second communication interface to transmit answer information corresponding to the handshake information to the first communication interface via the body transmission channel.

The first processor can determine that the user has put on the slave wearable device when the answer information is received, by the first communication interface, for more than a preset number of times within a preset time threshold.

When the first processor executes the first program command and when no corresponding answer information is received after the first communication interface transmits the handshake information, the first processor can confirm that the user has taken off the slave wearable device, and when confirming that the user has taken off the slave wearable device, the first processor can control the first monitor to display the display information.

Both the first communication interface and the second communication interface can be in contact with skin to ensure the openness of a body transmission channel.

The master wearable device can be a smart watch, and the slave wearable device can be a pair of smart glasses.

In an embodiment, a method for displaying wearable device display information may include: a master wearable device can be worn on the user's body. The master wearable device can detect whether a user has put on the slave wearable device via a body transmission channel formed within the user body. When the master wearable device determines that the user has put on the slave wearable device, the master wearable device can determine priority of the master wearable device and the slave wearable device, and when it is determined that the priority of the slave wearable device is higher than the priority of the master wearable device, the master wearable device can transmit the display information to the slave wearable device via the body transmission channel. The slave wearable device can display the display information on its own monitor.

When the master wearable device determines that the user has put on the slave wearable device, the master wearable device can further transmit handshake information to the slave wearable device regularly via the body transmission channel. The slave wearable device can transmit answer information corresponding to the handshake information to the master wearable device via the body transmission channel.

The master wearable device can determine that the user has put on the slave wearable device when the answer information is received for more than a preset number of times within a preset time threshold.

When no corresponding answer information is received after the master wearable device transmits the handshake information, the master wearable device can confirm that the user has taken off the slave wearable device, and display the display information on its own monitor.

The shell of the master wearable device that is in contact with the human body can form a body transmission channel within the human body with the shell of the slave wearable device that is in contact with the human body.

The master wearable device can be a smart watch, and the slave wearable device can be a pair of smart glasses.

Unlike the prior art, the method for displaying wearable device display information of the present invention can comprise: a master wearable device detects whether a user has put on a slave wearable device via a body transmission channel formed within the user body. When the master wearable device determines that the user has put on the slave wearable device, it can determine priority of the master wearable device and the slave wearable device, and when the priority of the slave wearable device is higher than the priority of the master wearable device, the master wearable device can transmit the display information to be displayed to the slave wearable device via the body transmission channel. The slave wearable device can display the display information on its own monitor. In the way described above, the present invention can automatically display information on a wearable device having a highest priority, which can greatly improve the flexibility of display for wearable devices and effectively improves the user experience.

### BRIEF DESCRIPTION OF THE DRAWINGS

FIG. 1 is a flow chart of the method for displaying wearable device display information according to an embodiment of the present invention;

FIG. 2 is a schematic diagram of the structure of the system for displaying wearable device display information according to an embodiment of the present invention;

FIG. 3 is a schematic diagram of the structure of the master wearable device according to the embodiment of the present invention shown in FIG. 2;

FIG. 4 is a schematic diagram of the structure of the slave wearable device according to the embodiment of the present invention shown in FIG. 2;

FIG. 5 is a structural schematic diagram of hardware of the system for displaying wearable device display information according to an embodiment of the present invention.

### DETAILED DESCRIPTION OF THE SPECIFIC EMBODIMENTS

The present invention will be further described in detail below with reference to the accompanying drawings and embodiments. It should be understood that the specific embodiments described herein are only used to explain the present invention, not limit the present invention.

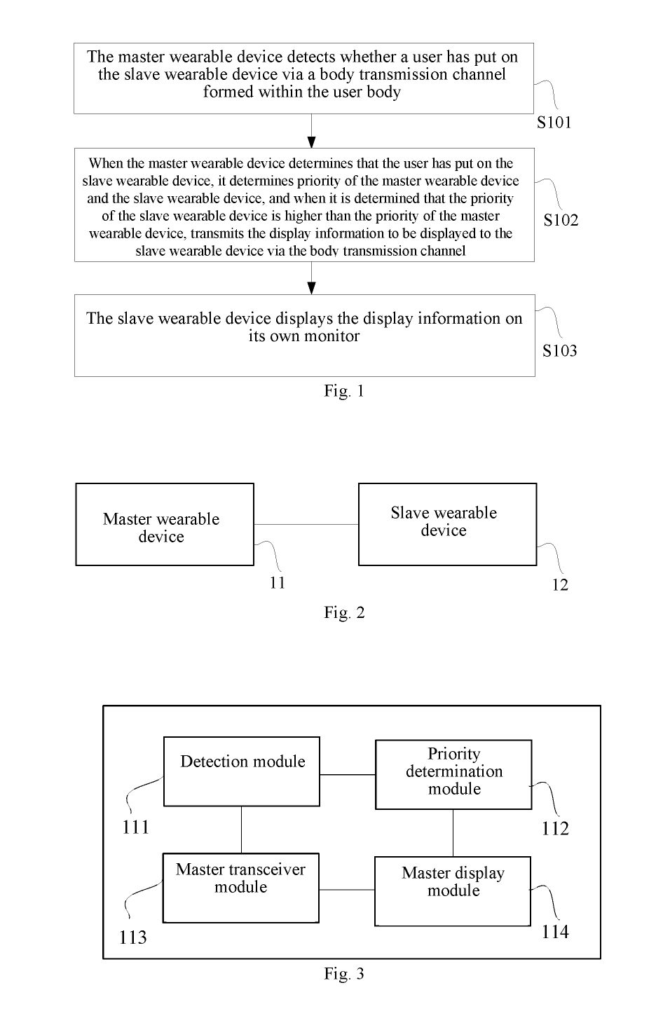

FIG. 1 is a flow chart of the method for displaying wearable device display information according to the present invention. Said method is applied to a master wearable device and a slave wearable device, and can comprise the following steps:

Step S101: the master wearable device can detect whether a user has put on the slave wearable device via a body transmission channel formed within the user body.

In an embodiment, the master wearable device can be worn on the user body, the master wearable device and the slave wearable device can use the human body as a transmission medium. Therefore, the master wearable device can transmit data via the human body, such as via skin, muscle or blood, and the slave wearable device can similarly transmit data via the human body, such as via skin, muscle or blood. When a user puts on the slave wearable device, a shell of the master wearable device that is in contact with the human body can form a body transmission channel within the human body with the shell of the slave wearable device that is in contact with the human body, and consequently the master wearable device can detect whether a user has put on the slave wearable device.

In Step S101, the master wearable device can transmit handshake information to the slave wearable device regularly via the body transmission channel, and if a user has put on the slave wearable device, the slave wearable device can receive the handshake information and feed answer information back to the master wearable device. The master wearable device can determine that the user has put on the slave wearable device, and the master wearable device and the slave wearable device can establish a body transmission channel. If the master wearable device does not receive answer information, the master wearable device can determine that the user does not put on the slave wearable device. When a user puts on the slave wearable device, the master wearable device may not receive answer information once or twice due to errors. To improve the accuracy, therefore, the master wearable device can determine that the user has put on the slave wearable device if the answer information is received for more than a preset number of times within a preset time.

Step S102: when the master wearable device determines that the user has put on the slave wearable device, the master wearable device can determine priority of the master wearable device and the slave wearable device, and when it is determined that the priority of the slave wearable device is higher than the priority of the master wearable device, the master wearable device can transmit the display information to be displayed to the slave wearable device via the body transmission channel.

The master wearable device can be a smart watch, the slave wearable device can be a pair of smart glasses, and the master wearable device and the slave wearable device may also be other wearable devices. The priority of the smart glasses may be higher than the priority of the smart watch.

In Step S102, if the display information transmitted has a small size, such as photos, audio or small files, or the requirement for transmission rate is not too high, when it is determined that the priority of the slave wearable device is higher than the priority of the master wearable device, the master wearable device can transmit the display information to be displayed to the slave wearable device via the body transmission channel. If the display information transmitted has a relatively large size, such as videos, or the requirement for transmission rate is relatively high, when it is determined that the priority of the slave wearable device is higher than the priority of the master wearable device, a wireless network connection can be established between the master wearable device and the slave wearable device, and the master wearable device can transmit the display information to be displayed to the slave wearable device via the wireless network connection.

In an embodiment, the priority of the master wearable device may be higher than the priority of the slave wearable device.

Step S103: the slave wearable device can display the display information on its own monitor.

In Step S103, when no corresponding answer information is received after the master wearable device transmits the handshake information, the master wearable device can confirm that the user has taken off the slave wearable device, and display the display information on its own monitor. When the answer information is received for less than a preset number of times within a preset time by the master wearable device, the master wearable device can determine that the user has taken off the slave wearable device, and display the display information on its own monitor.

After the slave wearable device displays the display information on its own monitor, the master wearable device can further transmit handshake information to the slave wearable device regularly via the body transmission channel, and if the user continues to wear the slave wearable device, the slave wearable device can transmit answer information corresponding to the handshake information to the master wearable device via the body transmission channel. If the user does not wear the slave wearable device, the master wearable device may not receive answer information, and at this moment, the master wearable device can display the display information on its own monitor, for example, when the master wearable device does not receive answer information, and still fails after having repeated the attempt for a number of times, it can be concluded that the slave wearable device has been taken off, and it can be switched to a default situation in which the master wearable device displays the display information.

FIG. 2 is a schematic diagram of the structure of the system for displaying wearable device display information according to the present invention, and the system in FIG. 2 corresponds to the method in FIG. 1. The system can comprise a master wearable device 11 and a slave wearable device 12. The master wearable device 11 can be worn on the user's body. The master wearable device 11 and the slave wearable device 12 can perform data transmission via a body transmission channel. In an embodiment, the master wearable device can be a smart watch, and the slave wearable device can be a pair of smart glasses, and the master wearable device and the slave wearable device may also be other wearable devices.

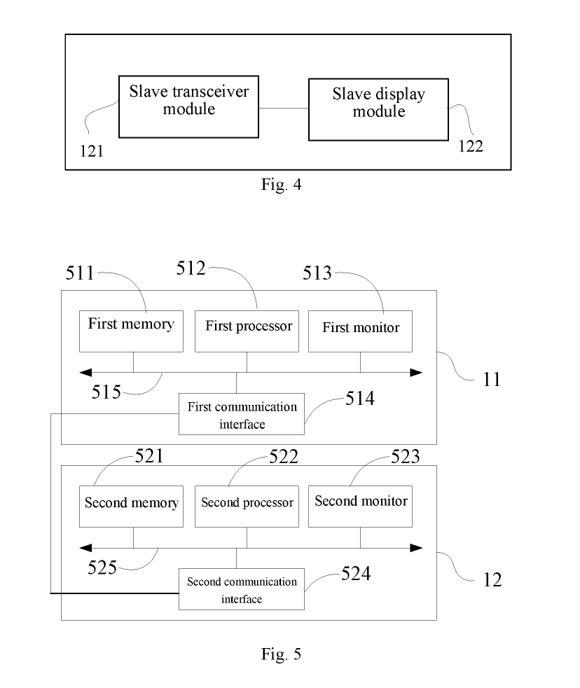

As shown in FIG. 3 and FIG. 4, the master wearable device 11 can comprise a detection module 111, a priority determination module 112, a master transceiver module 113, and a master display module 114. The slave wearable device 12 can comprise a slave transceiver module 121 and a slave display module 122.

The detection module 111 can be configured to detect whether a user has put on the slave wearable device 12 via a body transmission channel formed within the user's body. The detection module 111 can be further configured to, when the detection module determines that the user has put on the slave wearable device 12, further transmit handshake information to the slave wearable device 12 regularly via the body transmission channel. The detection module 111 can be further configured to, upon receiving corresponding answer information after the handshake information is transmitted, determine that the user has put on the slave wearable device 12. The detection module 111 can be further configured, when no corresponding answer information is received after the handshake information is transmitted, to confirm that the user has taken off the slave wearable device 12.

The master display module 114 can be configured, when the detection module 111 confirms that the user has taken off the slave wearable device 12, to display the display information.

The priority determination module 112 can be configured, when the detection module 111 confirms that the user has taken off the slave wearable device 12, to determine priority of the master wearable device 11 and the slave wearable device 12. In an embodiment, the priority of the smart glasses is higher than the priority of the smart watch.

The master transceiver module 113 can be configured, when the priority determination module 112 confirms that the priority of the slave wearable device 12 is higher than the priority of the master wearable device 11, to transmit the display information to be displayed to the slave wearable device 12 via the body transmission channel.

The slave display module 122 of the slave wearable device 12 can be configured, upon receiving the display information from the master transceiver module 113, to display the display information.

The slave transceiver module 121 can be configured to transmit answer information corresponding to the handshake information to the master wearable device 11 via the body transmission channel.

In an embodiment, a wireless network connection may be established between the master transceiver module 113 and the slave wearable device 12. A wireless network connection may be established between the slave transceiver module 121 and the master wearable device 11, and the master transceiver module 113 can transmit the display information to be displayed by the master wearable device 11 to the slave wearable device 12 via the wireless network connection.

In an embodiment, the master transceiver module 113 and the slave transceiver module are both provided with a sensing region, said sensing regions are both disposed on the side of the shell that is in contact with skin to ensure the openness of a body transmission channel. The sensing region of the smart glasses can be disposed on the nose support of the frame and can be in contact with face skin The sensing region can be disposed on the nose support of the frame and can be in contact with the skin of nose bridge, which can accurately determine whether a user has truly put on the smart glasses. On the other hand, the sensing region of the smart watch can be disposed on the face of a watch band that is in contact with skin to ensure the openness of a body transmission channel.

The master wearable device 11 can further comprise a master body communication module (not shown) configured to perform data transmission via the human body. The slave wearable device 12 further can comprise a slave body communication module (not shown) configured to perform data transmission via the human body. The master body communication module and the slave body communication module can form a body transmission channel within the human body for data transmission. The master body communication module and the slave body communication module both can comprise body communication chips.

FIG. 5 is a structural schematic diagram of the hardware of the system for displaying wearable device display information according to the present invention. As shown in FIG. 5, the display system can comprise a master wearable device 11 and a slave wearable device 12. The master wearable device 11 can be worn on the user's body. The master wearable device 11 can comprise a first bus 515 and a first memory 511, a first processor 512, a first communication interface 514, and a first monitor 513 that are connected to the first bus 515. The slave wearable device 12 can comprise a second bus 525 and a second memory 521, a second processor 522, a second communication interface 524, and a second monitor 523 that are connected to the second bus 525. The first memory 611 can store a first program command, the first processor 612 can be configured to execute the first program command, the second memory 621 can store a second program command, and the second processor 622 can be configured to execute the second program command.

The first communication interface 514 and the second communication interface 524 can both be in contact with skin to ensure the openness of a body transmission channel.

The first processor 512 can execute the first program command to control the first communication interface 514 to detect whether a user has put on the slave wearable device 12 via a body transmission channel formed within the user's body; when the first processor 512 executes the first program command and determines that the user has put on the slave wearable device 12, the first processor 512 can execute the first program command to determine priority of the master wearable device 11 and the slave wearable device 12, the first processor 512 can execute the first program command to control the first communication interface 514, when it is determined that the priority of the slave wearable device 12 is higher than the priority of the master wearable device 11, to transmit the display information to be displayed to the second communication interface 524 via the body transmission channel. When the second communication interface 524 receives the display information transmitted from the first communication interface 514, the second processor 522 can execute the second program command to control the second monitor 523 to display the display information.

When the first processor 512 executes the first program command and determines that the user has put on the slave wearable device 12, the first processor 512 can further execute the first program command to control the first communication interface 514 to transmit handshake information to the second communication interface 524 regularly via the body transmission channel, and the second processor 522 can execute the second program command to control the second communication interface 524 to transmit answer information corresponding to the handshake information to the first communication interface 514 via the body transmission channel. When the first processor 512 executes the first program command and when no corresponding answer information is received after the first communication interface 514 transmits the handshake information, the first processor 512 can confirm that the user has taken off the slave wearable device 12, and when the first processor confirms that the user has taken off the slave wearable device 12, the first processor 512 can control the first monitor 513 to display the display information.

In an embodiment, the first processor 512 can determine that the user has put on the slave wearable device 12 when the answer information is received, by the first communication interface 514, for more than a preset number of times within a preset time threshold. If the answer information is received for less than a preset number of times within a preset time by the first communication interface 514, the first processor 512 determines that the user has taken off the slave wearable device 12.

The first memory 511 and the second memory 521 may be a variety of media capable of storing program codes, such as flash drives, portable hard drives, Read-Only Memory (ROM), Random Access Memory (RAM), magnetic disks or optical disks.

The master wearable device 11 can be a smart watch, and the slave wearable device 12 can be a pair of smart glasses.

The method for displaying wearable device display information of the present invention can comprise: a master wearable device detects whether a user has put on a slave wearable device via a body transmission channel formed within the user body. When the master wearable device determines that the user has put on the slave wearable device, the master wearable device can determine priority of the master wearable device and the slave wearable device. When the priority of the slave wearable device is higher than the priority of the master wearable device, the master wearable device can transmit the display information to be displayed to the slave wearable device via the body transmission channel; the slave wearable device can display the display information on its own monitor. In an embodiment described above, the present invention can automatically display information on a wearable device having a highest priority, which can greatly improve the flexibility of display for wearable devices and can effectively improve the user experience.

Embodiments of the present invention are described above with reference to the accompanying drawings, which are not to limit the scope of the present invention. Modification, equivalent substitution and improvement can be made by a person skilled in the art without departing from the scope and essence of the present invention.

1. A system for displaying wearable device display information, wherein the system comprises a master wearable device and a slave wearable device, the master wearable device is worn on the user body, wherein the master wearable device comprises a first bus, a first memory, a first processor, a first communication interface, and a first monitor, wherein the first memory, the first processor, the first communication interface, and the first monitor are connected to the first bus;
the slave wearable device comprises a second bus, a second memory, a second processor, a second communication interface, and a second monitor, wherein the second memory, the second processor, the second communication interface, and the second monitor are connected to the second bus;
the first memory stores a first program command, the first processor is configured to execute the first program command, the second memory stores a second program command, the second processor is configured to execute the second program command, and both the first communication interface and the second communication interface are in contact with skin to ensure the openness of a body transmission channel; wherein:
the first processor executes the first program command to control the first communication interface to detect whether a user has put on the slave wearable device via a body transmission channel formed within the user body;
when the first processor executes the first program command and determines that the user has put on the slave wearable device, the first processor determines priority of the master wearable device and the slave wearable device;
the first processor executes the first program command to control the first communication interface, when it is determined that the priority of the slave wearable device is higher than the priority of the master wearable device, to transmit the display information to be displayed to the second communication interface via the body transmission channel;
when the second communication interface receives the display information transmitted from the first communication interface, the second processor executes the second program command to control the second monitor to display the display information;
when the first processor executes the first program command and determines that the user has put on the slave wearable device, the first processor is configured to execute the first program command to control the first communication interface to transmit handshake information to the second communication interface regularly via the body transmission channel;
the second processor is configured to execute the second program command to control the second communication interface to transmit answer information corresponding to the handshake information to the first communication interface via the body transmission channel;
when the first processor executes the first program command and when no corresponding answer information is received after the first communication interface transmits the handshake information, the first processor is configured to confirm that the user has taken off the slave wearable device, and when confirming that the user has taken off the slave wearable device, the first processor is configured to control the first monitor to display the display information.

2. The system according to claim 1, wherein the first processor is configured to determine that the user has put on the slave wearable device when the answer information is received, by the first communication interface, for more than a preset number of times within a preset time threshold.

3. The system according to claim 1, wherein the master wearable device is a smart watch, and the slave wearable device is a pair of smart glasses.

4. A system for displaying wearable device display information, comprising:
a master wearable device and a slave wearable device, the master wearable device is worn on a user's body, the master wearable device comprises a first bus, a first memory, a first processor, a first communication interface, and a first monitor, wherein the first memory, the first processor, the first communication interface, and the first monitor are connected to the first bus, the slave wearable device comprises a second bus, a second memory, a second processor, a second communication interface, and a second monitor, wherein the second memory, the second processor, the second communication interface, and the second monitor are connected to the second bus, the first memory stores a first program command, the first processor is configured to execute the first program command, the second memory stores a second program command, and the second processor is configured to execute the second program command,
wherein:
the first processor is configured to execute the first program command to control the first communication interface to detect whether a user has put on the slave wearable device via a body transmission channel formed within the user's body;
when the first processor executes the first program command and determines that the user has put on the slave wearable device, the first processor is configured to determine priority of the master wearable device and the slave wearable device;
the first processor is configured to execute the first program command to control the first communication interface, when it is determined that the priority of the slave wearable device is higher than the priority of the master wearable device, to transmit the display information to be displayed to the second communication interface via the body transmission channel;
when the second communication interface receives the display information transmitted from the first communication interface, the second processor is configured to execute the second program command to control the second monitor to display the display information.

5. The system according to claim 4, wherein, when the first processor executes the first program command and determines that the user has put on the slave wearable device, the first processor further is configured to execute the first program command to control the first communication interface to transmit handshake information to the second communication interface regularly via the body transmission channel, and the second processor is configured to execute the second program command to control the second communication interface to transmit answer information corresponding to the handshake information to the first communication interface via the body transmission channel.

6. The system according to claim 5, wherein the first processor is configured to determine that the user has put on the slave wearable device when the answer information is received, by the first communication interface, for more than a preset number of times within a preset time threshold.

7. The system according to claim 5, wherein when the first processor is configured to execute the first program command and when no corresponding answer information is received after the first communication interface transmits the handshake information, the first processor is configured to confirm that the user has taken off the slave wearable device, and when confirming that the user has taken off the slave wearable device, the first processor is configured to control the first monitor to display the display information.

8. The system according to claim 4, wherein both the first communication interface and the second communication interface are in contact with skin to ensure the openness of a body transmission channel.

9. The system according to claim 4, wherein the master wearable device is a smart watch, and the slave wearable device is a pair of smart glasses.

10. A method for displaying wearable device display information, wherein said method is applied to a master wearable device and a slave wearable device, the master wearable device is worn on a user's body, said method comprises:
the master wearable device detects whether a user has put on the slave wearable device via a body transmission channel formed within the user's body;
when the master wearable device determines that the user has put on the slave wearable device, it the master wearable device determines priority of the master wearable device and the slave wearable device, and when it is determined that the priority of the slave wearable device is higher than the priority of the master wearable device, the master wearable device transmits the display information to the slave wearable device via the body transmission channel; and
the slave wearable device displays the display information on its own monitor.

11. The method according to claim 10, wherein, when the master wearable device determines that the user has put on the slave wearable device, 4-the master wearable device further transmits handshake information to the slave wearable device regularly via the body transmission channel, and the slave wearable device transmits answer information corresponding to the handshake information to the master wearable device via the body transmission channel.

12. The method according to claim 11, wherein the master wearable device determines that the user has put on the slave wearable device when the answer information is received for more than a preset number of times within a preset time threshold.

13. The method according to claim 11, wherein, when no corresponding answer information is received after the master wearable device transmits the handshake information, the master wearable device confirms that the user has taken off the slave wearable device, and displays the display information on its own monitor.

14. The method according to claim 10, wherein a shell of the master wearable device that is in contact with the human body forms a body transmission channel within the human body with the shell of the slave wearable device that is in contact with a human body.

15. The method according to claim 10, wherein the master wearable device is a smart watch, and the slave wearable device is a pair of smart glasses.

16. The method of claim 10, wherein the master wearable device comprises a first bus, a first memory, a first processor, a first communication interface, and a first monitor.

17. The method of claim 16, wherein the first memory, the first processor, the first communication interface, and the first monitor are connected to a first bus.

18. The method of claim 16, wherein the slave wearable device comprises a second bus, a second memory, a second processor, a second communication interface, and a second monitor,

19. The method of claim 18, wherein the second memory, the second processor, the second communication interface, and the second monitor are connected to a second bus.

20. The system of claim 19, wherein the first processor controls the first monitor, and the second process controls the second monitor.
